(19) United States
(12) Patent Application Publication
(10) Pub. No.: US 2014/0189666 A1
(43) Pub. Date: Jul. 3, 2014

(54) AUTOMATIC PIPELINE COMPOSITION

(71) Applicants: Scott A. Krig, Folsom, CA (US); Michael D. Jeronimo, Wilsonville, OR (US)

(72) Inventors: Scott A. Krig, Folsom, CA (US); Michael D. Jeronimo, Wilsonville, OR (US)

(21) Appl. No.: 13/728,681

(22) Filed: Dec. 27, 2012

(51) Int. Cl. G06F 9/45

(52) U.S. Cl. CPC G06F 8/443
USPC 717/160

(57) ABSTRACT

A method and apparatus for automatic pipeline are provided herein. Syntax elements may be manually inserted into the code, or automatically injected into the code. The syntax elements may specify hints such as data type parameters to independent functions allowing the functions to be automatically coalesced into a single loop, providing optimized data accesses to be coalesced for each function in the pipeline within the single loop. A run-time system produces optimized machine code for a target processor using syntax elements to guide the optimizations. Additionally, the pipeline may be executed. The pipeline includes the coalesced functions and data accesses.

### TECHNICAL FIELD

This disclosure relates generally to imaging operations. More specifically, the disclosure relates to automatically composing a pipeline for imaging operations.

### BACKGROUND ART

Pipelines for image processing are typically pieced together manually by a user with knowledge of the computing architecture as well as the particular imaging algorithms to be processed. Such pipelines are time consuming to construct, while being non-portable across computing architectures.

### BRIEF DESCRIPTION OF THE DRAWINGS

The following detailed description may be better understood by referencing the accompanying drawings, which contain specific examples of numerous objects and features of the disclosed subject matter.

FIG. 1A is a block diagram of functions before being coalesced into optimized functions, in accordance with embodiments;

FIG. 1B is a block diagram of functions after being coalesced into optimized functions, in accordance with embodiments;

FIG. 2 is a process flow diagram for an automatic pipeline composition, in accordance with embodiments;

FIG. 3 is an illustration of a vision pipeline of a Sobel operator, in accordance with embodiments;

FIG. 4 is a block diagram of a computing device 400 that may be used in accordance with embodiments; and

FIG. 5 is a block diagram showing tangible, non-transitory computer-readable media 500 that stores code for automatic pipeline composition, in accordance with embodiments.

### DESCRIPTION OF THE EMBODIMENTS

As discussed above, manually constructed pipelines are time consuming to generate, while being non-portable across computing architectures. As a result, imaging pipelines become cost prohibitive.

Embodiments of the present techniques provide for an automatic pipeline composition that is portable across computing architectures. In embodiments, the pipelines include a set of individual primitive functions that are coalesced into a single outer loop. Additionally, in embodiments, data access for all primitive functions in the outer loop is coalesced. In this manner, the memory and computational resources of a computing system may be optimized using an algorithm description that is portable across computing architectures. Additionally, data copying may be reduced, which eliminates data passing, allows data values to be stored in fast registers within the compute units, eliminates cache misses, reduces overall memory bandwidth, saves power, and increases performance.

Additionally, techniques described herein provide for either manual or automatic function coalescing into pipelines sharing a common outer loop and data read write access. In the manual techniques, a programmer may insert syntax elements into the code to mark function data types and other attributes which enables the techniques described herein to be used to compile or translate the code into coalesced and optimized pipelines. The coalesced optimized pipelines share a common outer loop and data read or write optimizations. In the automatic techniques, a compiler or translator may examine the source code and automatically infer the syntax elements that should be inserted into the code to enable the function coalescing and common outer loop and shared data read or write optimizations. In embodiments, the syntax elements are automatically inserted into compiled and translated code, transparently to the software programmer. Accordingly, the techniques described herein enable manually inserting syntax elements into the code to guide to coalescing into pipeline sharing the outer loop and combining data reads or writes, using automatic static code analysis to automatically translate the code into lower level optimized code, or translating the code into other code with syntax elements automatically inserted to guide the coalescing of functions into pipelines sharing an outer loop and combined data reads and writes.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

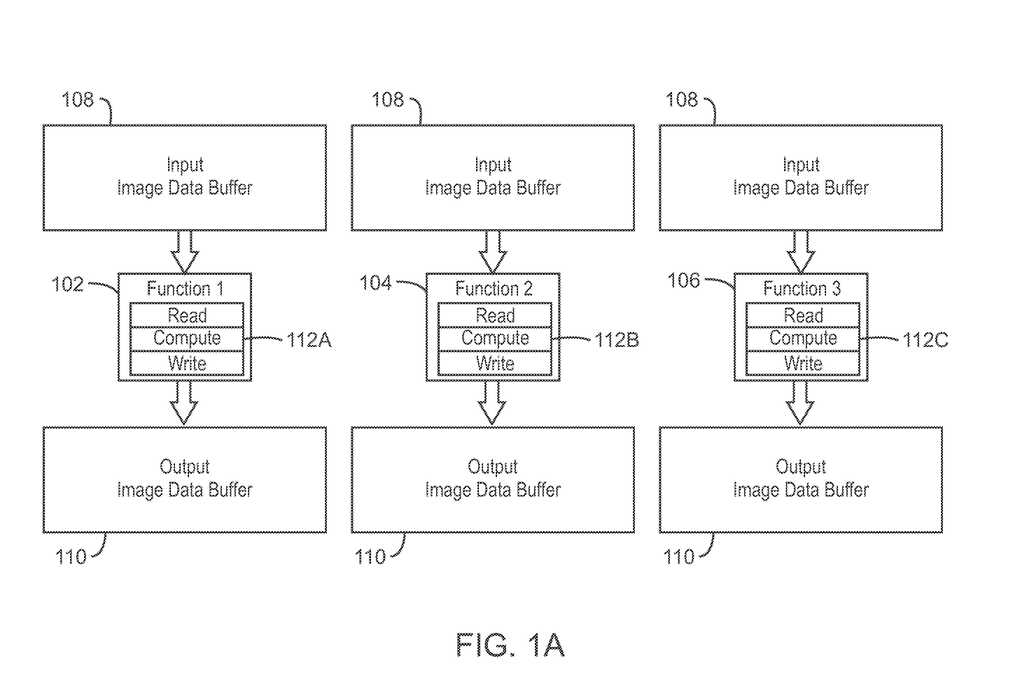

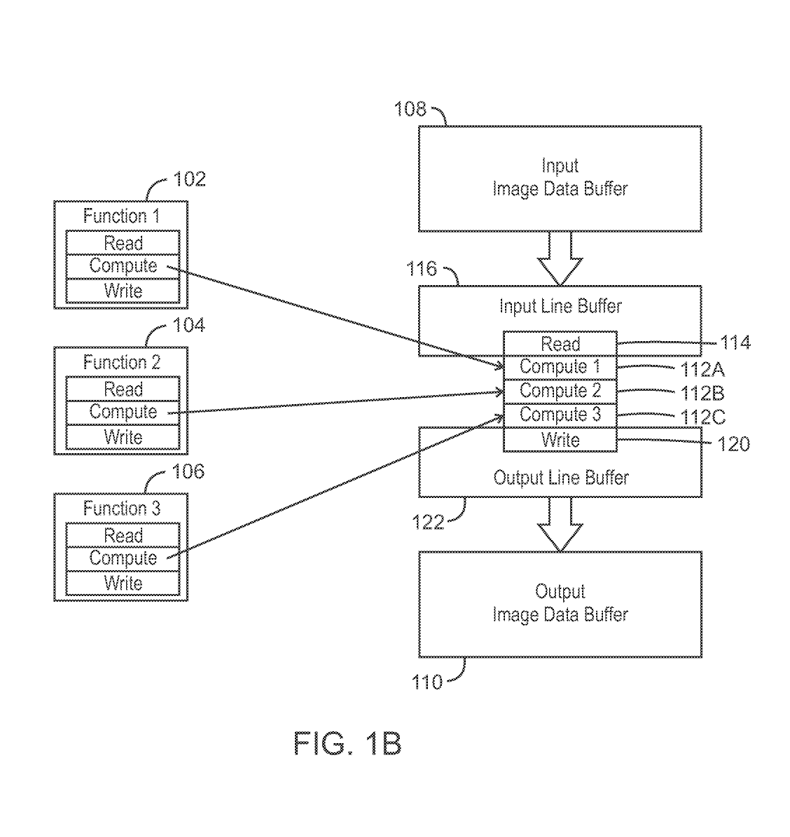

FIG. 1A is a block diagram of functions before being coalesced into optimized functions, in accordance with embodiments. FIG. 1A includes a function 102, a function 104, and a function 106. Each function may be executed by independently reading the necessary data from an input image data buffer 108. Each function then performs its own independent computations, and writes the resulting data to an output image data buffer 110.

For example, the function 102 may read data from the input image data buffer 108. Although the input image data buffer 108 is the same for each of the function 102, the function 104, and the function 106, the images in the input image data buffer may be read from different locations in memory. The function 102 then performs a computation 112A on the data, and then writes the resulting data to an output image data buffer 110. Similarly, the function 104 performs a computation 112B and the function 3 performs a computation 112C. In embodiments, the data in the output image data buffer 110 is written to the same place in memory from where it was retrieved, which is referred to as computing data in place. Accordingly, each function 102, function 104, and function 106 includes its own computations, specifically, the compute 112A, the compute 112B, and the compute 112C, respectively.

FIG. 1B is a block diagram of functions after being coalesced into optimized functions, in accordance with embodiments. When each of the function 102, function 104, and function 106 are coalesced as described herein, one single read operation 114 occurs to read the data necessary for each of the function 102, function 104, and function 106. The data may be read from an input line buffer 116, which receives data from the input image data buffer 108. Although the input to the read operation 114 is shown as a line in the input line buffer 116, the input to the read operation 114 may be a point, line, region, area, structured data, algorithmic random data, or any combination thereof. After input to the read operation, the data then is passed in fast registers and cache memory between primitive functions in the pipeline, increasing performance and decreasing memory bandwidth. Accordingly, the data may be passed among the primitive functions without being written to memory.

After each respective compute operation 112A, 112B, and 112C is complete, one write operation 120 occurs to write the resulting data from the function 102, function 104, and function 106. The data is written to an output line buffer 122. The output line buffer 122 may then write data to the output image data buffer 110. Although the output is shown as an output line buffer 122, the output to the output image data buffer 110 may be a point, line, region, area, structured data, algorithmic random data, or any combination thereof. Further, the format of input data is not necessarily the same as the format of the output data.

Using the present techniques, each of the function 102, the function 104, and the function 106 may be coalesced together, wherein each of the functions shares a common read operation and a common write operation. In this manner, the read buffer may be optimized separately such that smaller pieces of data are read into the buffer to avoid cache misses. By coalescing the functions, performance savings are provided. Accordingly, each function can be coalesced on the fly, without reading from memory for each data input. When used with operations that are element by element, memory is not accessed each time an element is operated on. Additionally, operations may be performed in parallel and optimized accordingly to hardware support. In embodiments, the method of coalescing functions is related to the data types used by the functions. For example, if a set of functions in the pipeline use a rectangular region of the same size, the data pre-fetch read may be fed to each function that a processes a rectangular region of the same size. The functions may then process those rectangular regions in parallel. Additionally, in embodiments, the present techniques enable functions to be marked in source code to designate the common data types. The data type syntax elements introduced into the source code to designate the common data types enable a compiler or translator to assemble the pipelines and generate code to handle the data pre-fetches, reads, or writes according to the data types.

In examples, an image could be input from a video camera. A function 102 could be used to sharpen the image, a function 104 could be used to enhance the color of the image, and a function 106 could be used to equalize the grayscale of the image. Without automatic pipeline composition, the entire image would be sharpened using function 102 before the color of the image was enhanced using function 104. In this manner, the image would be obtained from the input image data buffer 108, sharpened, and then written to the output image data buffer 110. In embodiments, the image may be written back to the same location from where it was retrieved in memory. After the entire image is sharpened, the color of the image may then be enhanced using function 104 without sending the function back to memory. Finally, the function 106 may be used to equalize the grayscale of the image before it is written to memory. After the function 106, the image data may be written to a location in memory using the output image data buffer 110. Performing the functions in a sequential manner, without writing the data to memory after each function, eliminates duplicated readings of the image and fewer cache misses.

The data type syntax elements introduced into the source code to designate the common data types enable a compiler or translator to assemble the pipelines and generate code to handle the data pre-fetches, reads, or writes according to the data types. The data attributes inserted into the code are any information that can be attached to data items within the code in order to describe the organization of the code. For example, the data attributes may be attached to individual data items to describe data organization. The data organization can specify what data is needed to complete certain operations or functions, and what data could is needed to start or complete particular operations or functions. Data attributes may also be used to define attributes of a data buffer. In embodiments, the data organization can provide hints for the automatic optimization syntax elements. Data attributes apply to global, local, or parameter data, and describe how this data may be used. In embodiments, a data buffer or buffer may be referred to as a matrix, an image, or an array.

Compute attributes may also be inserted into the code. The compute attributes are attached to any compute item within the code that can be used to describe the techniques by which data buffers or memory accesses are organized. The compute attributes may also be attached to any compute item within the code that describes a particular function being performed by the code. The compute attributes enable data buffer optimizations, memory access optimizations, and function coalescing. Compute attributes may include types for various shapes of processing such as point data, line data, area data, structured data, algorithmic random data, or any combination thereof. Each type or shape of data access uses a different method for optimization. For example, points, lines and area regions each require different memory optimizations, as the technique for accessing memory differs with each shape. Additionally, compute attributes allow automatic optimizations for cache memory policy to minimize page faults and localize memory access according to the compute attribute for a given function.

The pseudo code below illustrates an embodiment of data types and code pragma's to enable both inferred optimizations and explicit optimizations. In an embodiment, a static code analyzer may infer the appropriate data types

```
//
// UNOPTIMIZED NORMAL CODE, 3 FUNCTIONS
//
Funtion1 (IN imageBuffer1, OUT imageBuffer2)
{
  Read Image Data until finished:
    Compute operation1 on Data
    write Image Data
  Done
}
Funtion2 (IN imageBuffer1, OUT imageBuffer2)
{
  Read Image Data until finished:
    Compute operation2 on Data
    write Image Data
  Done
}
Funtion3 (IN imageBuffer1, OUT imageBuffer2)
{
  Read Image Data until finished:
    Compute operation3 on Data
    write Image Data
  Done
}
Main( )
{
  Function1(image1, image2)
  Function2(image1, image2)
  Function3(image1, image2)
}
//
// MODIFIED CODE SHOWING OPTIMIZATION BY ‘Lineoptimized’
FUNCTION TYPE
//
LineOptimized_t Funtion1 (IN imageBuffer1, OUT imageBuffer2)
{
  Read Image Data until finished:
    Compute operation1 on Data
    write Image Data
  Done
}
LineOptimized_t Funtion2 (IN imageBuffer1, OUT imageBuffer2)
{
  Read Image Data until finished:
    Compute operation2 on Data
    write Image Data
  Done
}
LineOptimized_t Funtion1 (IN imageBuffer1, OUT imageBuffer2)
{
  Read Image Data until finished:
    Compute operation3 on Data
    write Image Data
  Done
}
//
// SW engineer creates this code, OPTIMIZED CODE is created
automatically as shown below
//
Pipeline_t PipelineSegment
{
  Function1, Function2, Function3
}
Main( )
{
PipelneSegment( )
}
//
// OPTIMIZED CODE FROM ABOVE FUNCTION ‘PipelineSegment’,
THIS CODE IS AUTO_GENERATED BY THE APS METHOD
//
AUTOGENERATED PipelineSegment(IN imageBuffer1 , OUT image
Buffer2)
{
  Read Image Data until finished:
    Compute operation1 on Data
    Compute operation2 on Data
    Compute operation3 on Data
    write Image Data
  Done
}
```

The code above illustrates data types and code pragma's to enable both inferred optimizations and explicit optimizations. Explicit optimizations are inserted by the software engineer in the source code language. Inferred optimizations are inserted into lower layers of code automatically based on static analysis of the source code language, for example, inserted into assembled language or LLVM code.

In embodiments, it is useful to provide a range of syntax elements into the code to enable data optimizations and reveal opportunities to coalesce functions. Additionally, in embodiments, specific attributes may be used to describe the exact data type information, as well as the use of the data. Attributes in an embodiment may include the following syntactic elements as described below, such as data attributes or compute attributes, to describe how data is used.

.As illustrated above, the un-optimized code include three independent functions with three separate read operations, compute operations (functions), and write operations. Through the addition of syntax elements, each function may be optimized by inserting a line optimized syntax element to designate the following function as on that accepts line type data, as illustrated above. The line optimized syntax elements enables each of the function 1, function 2, and function 3 to be coalesced together to share a common read operation and a common write operation, as each compute operation uses a line of data as an input.

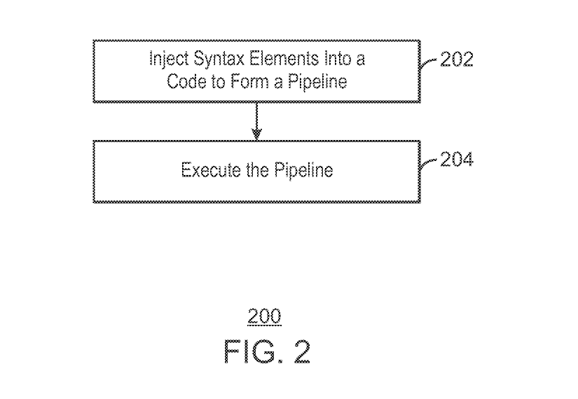

FIG. 2 is a process flow diagram for an automatic pipeline composition, in accordance with embodiments. At block 202, syntax elements are injected to the code, wherein the syntax elements specify independent functions to be coalesced into a single loop, and data accesses to be coalesced for each function. In embodiments, the code may be a high level language and a programmer may explicitly inject the syntax elements into the high level code. Additionally, in embodiments, the code may be an intermediate level code wherein the compiler injects the data attributes and the compute attributes into the code as it is compiled. The compiler may infer the data attributes or insert them transparently to any programmer. Further, in embodiments, the code may be an assembly level or native code wherein the data attributes and compute attributes are injected into the assembly level or native code at runtime.

The syntax elements include data attributes that describe the data to be processed by each function. For example, an in place data attribute can be used to specify that the input image is also the output image, thus, the data of the function should be processed in place. An output complete data attribute specifies that the entire data object must be processed before continuing with any other function. Similarly, an input complete data attribute signifies that a data object should be ready to process before starting the execution of the associated function. An input partial ok data attribute signifies that only a part of the input data must be ready to start the execution of the associated function. Similarly, an output partial ok data attribute signifies that only part of the data can be passed down the pipeline while the remainder to the data is being processed by the associated function. Additionally, in examples, an out of order data attribute applies to both input and output. The out of order data attribute signifies that the data associated with a particular function can be processed in any order. Further, an input unrestricted or output unrestricted data attribute places no restrictions on the data input or output of the associated function. In embodiments, any of the above data attributes may be inferred by high level graph analysis, explicitly specified in the high level language, or inserted into an intermediate code representation transparently to a programmer.

The injected syntax elements also include compute attributes that enable data buffer optimizations, memory buffer optimizations, and function coalescing. Compute attributes include attribute types for various shapes of data that is accessed for processing, including points, lines, areas, structured types, random data, or any combination thereof. Each type or shape of data accessed in memory employs a different method for optimization, as the techniques for accessing data in memory may vary depending on the shape or type of data accessed. Further, the data buffer may be optimized depending on the data type that is accessed in memory. For example, the data buffer may be sized to accommodate the smallest unit of memory that is accessed. In this manner, the data buffer can be used to optimize cache memory policies in order to minimize page faults and localize memory access for a given function. Compute attributes include types for various shapes of processing including points, lines, areas, structured types, and random data. Each type or shape of data access requires a different method for optimization. For example, points, lines and area regions each require different memory optimizations. Compute attributes enable automatic optimizations for cache memory policy to minimize page faults and localize memory access according to the compute attribute for a given function. In examples, the compute attributes may include point data compute attributes, where every output element is a function of the corresponding input element. An area data compute attribute signifies when the output element at a specific position is a function of an input area (kernel, edge conditions). A line data compute attribute signifies when the output element is a function of an input line. The structured data compute attribute signifies when the data is in a structured format, but will use random access within the structure. Structured data could be, for example, when one data point has other data associated with that point. For example, a pixel may have associated texture and depth information that can be placed in a structured data format. Additionally, an algorithmic random data compute attribute (lots of branching) signifies when the output element is a function of an arbitrary number of input elements. In embodiments, these compute attributes may be inferred by high level graph analysis or explicitly specified in the high level language of the code. Moreover, the compute attributes may be inserted into an intermediate code representation transparently to any programmer.

Although the present techniques are described using a function as the unit of analysis, the present techniques may also be applied to an element-by-element analysis of the code. For example, elements within each function may be coalesced into one single function of a pipeline that performs the same computations as functions of the original code.

At block 204, the pipeline is executed, wherein the pipeline comprises the coalesced functions and data accesses. In embodiments, a pipeline composition manager may use a combination of static code analysis to auto-generate new code. The new code includes syntax elements injected into the code. Additionally, in embodiments, the pipeline composition manager may interpret previously injected syntax elements in order to coalesce functions together into common outer loops which share the same data being passed into the loop and used in a pipeline between functions composed into the loop. The pipeline manager may configure data buffers based on the shape of incoming data. For example, the data buffer may be implemented as sliding area or a sliding line buffer. In embodiments, the sliding line buffer may include a sliding area buffer.

Specifically, the pipeline composition manager may first perform data buffering reductions and optimizations. Both the size and copy reductions can be done independently for both input and output buffers between functions. Next, the pipeline composition manager may perform function level coalescing into fewer loops. Based on the input/output buffer requirements for each function, function combinations are possible where functions are coalesced together to take multiple functions and combine them together into a single function or loop. As discussed above, the data attributes enable optimizations at the compiler level and run-time level. For example, the syntax elements may be injected and the corresponding optimizations may be performed in any language including low level virtual machine (LLVM), C, assembler language, or other languages. As a result, the syntax elements and the resulting pipeline composed based on the syntax elements can be ported to any machine for use on any hardware configuration.

In embodiments, code pragmas to enable both inferred optimizations and explicit optimizations. Additionally, a static code analyzer may infer the appropriate data types when injecting the compute attributes. Explicit optimizations may be inserted by the software engineer in the source code language. Inferred optimizations are inserted into lower layers of code automatically based on static analysis of the source code language, for example, inserted into assembled language or LLVM code. In addition to code pragmas, compiler flags may also be used to inject syntax elements into the code as described above.

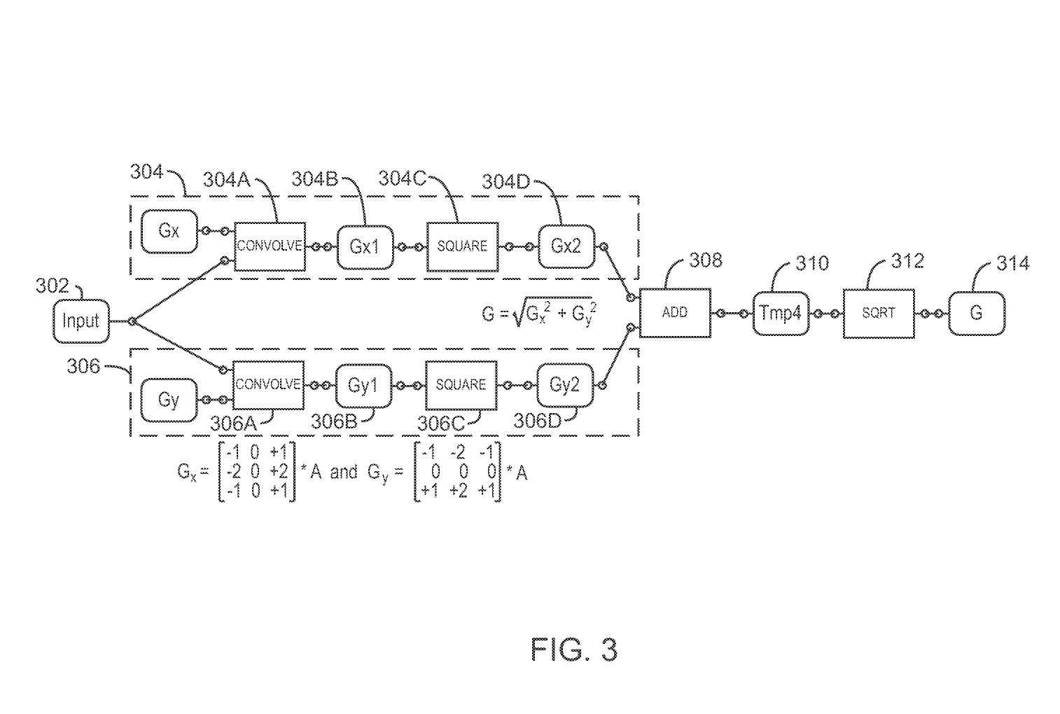

FIG. 3 is an illustration of a vision pipeline of a Sobel operator, in accordance with embodiments. The Sobel operator is used in edge detection algorithms within image processing. Using the Sobel operator, the image is convolved with a matrix in order to apply filters to the image in both a horizontal and vertical direction. The result of the Sobel operator on the image is a gradient of the image intensity at each point of the image. The edges of the image may be found at points in the image where in the image intensity is a zero vector.

At block 302, an input image A is provided as an input to the Sobel operator. At block 304, a 3×3 kernel Gx is convolved with the input image A where the matrix Gx is used to calculate approximations of the horizontal derivatives. The convolve operation occurs at block 304A, and the resulting data is fed into a buffer at block 304B. The data from the buffer 304B is the fed to a square function 304C. The data that results from the square function is fed to a buffer at 304D.

Similarly, at block 306, a 3×3 kernel Gy is convolved with the input image A where the matrix Gy is used to calculate approximations of the vertical derivatives. The convolve operation occurs at block 306A, and the resulting data is fed into a buffer at block 306B. The data from the buffer 306B is the fed to a square function 306C. The data that results from the square function is fed to a buffer at 306D.

After both inputs arrive at the buffers 304D and 306D, the data may be sent to an add function at block 308, and sent to a buffer at block 310. A square root function may be applied to the data at block 312. After the square root is applied at block 312, the resulting data is the image intensity for each point within the original input image A. As described herein, the Sobel operator is performed using syntax elements to coalesce the various operations involved into a common outer loop that shares data. The data may then be passed between the operations in the outer loop without writing the data to memory.

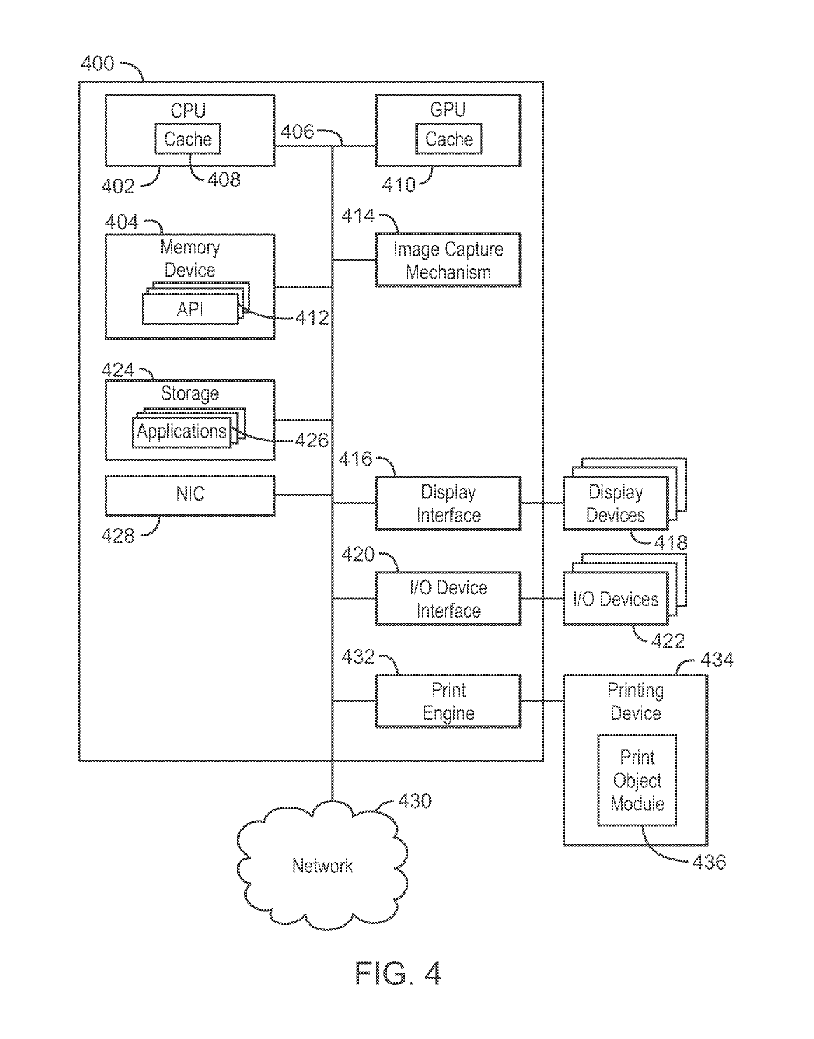

FIG. 4 is a block diagram of a computing device 400 that may be used in accordance with embodiments. The computing device 400 may be, for example, a laptop computer, desktop computer, tablet computer, mobile device, or server, among others. The computing device may also be a printing device or an image capture mechanism. The computing device 400 may include a central processing unit (CPU) 402 that is configured to execute stored instructions, as well as a memory device 404 that stores instructions that are executable by the CPU 402. The CPU may be coupled to the memory device 404 by a bus 406. The CPU also includes a cache 408. In embodiments, the automatic pipeline composition may be optimized according to the size of the CPU cache 408. Additionally, the CPU 402 can be a single core processor, a multi-core processor, a computing cluster, or any number of other configurations. Furthermore, the computing device 400 may include more than one CPU 402. The instructions that are executed by the CPU 402 may be used to enable an automatic pipeline composition as described herein.

The computing device 400 may also include a graphics processing unit (GPU) 408. As shown, the CPU 402 may be coupled through the bus 406 to the GPU 408. The GPU 408 may be configured to perform any number of graphics operations within the computing device 400. For example, the GPU 408 may be configured to render or manipulate graphics images, graphics frames, videos, or the like, to be displayed to a user of the computing device 400. In some embodiments, the GPU 408 includes a number of graphics engines (not shown), wherein each graphics engine is configured to perform specific graphics tasks, or to execute specific types of workloads. The GPU also includes a cache 410. In embodiments, the automatic pipeline composition may be optimized according to the size of the CPU cache 410.

The memory device 404 can include random access memory (RAM), read only memory (ROM), flash memory, or any other suitable memory systems. For example, the memory device 404 may include dynamic random access memory (DRAM). The memory device 404 may include an application programming interfaces (APIs) 412 that are configured to inject syntax elements into image processing code, in accordance with embodiments. The memory device 404 may also include a code store that is used to store the code to be processed.

The computing device 400 includes an image capture mechanism 414. In embodiments, the image capture mechanism 414 is a camera, stereoscopic camera, infrared sensor, or the like. The image capture mechanism 414 is used to capture image information to be processed. Accordingly, the computing device 400 may also include one or more sensors.

The CPU 402 may be connected through the bus 406 to an input/output (I/O) device interface 416 configured to connect the computing device 400 to one or more I/O devices 418. The I/O devices 418 may include, for example, a keyboard and a pointing device, wherein the pointing device may include a touchpad or a touchscreen, among others. The I/O devices 418 may be built-in components of the computing device 400, or may be devices that are externally connected to the computing device 400.

The CPU 402 may also be linked through the bus 406 to a display interface 420 configured to connect the computing device 400 to a display device 422. The display device 422 may include a display screen that is a built-in component of the computing device 400. The display device 422 may also include a computer monitor, television, or projector, among others, that is externally connected to the computing device 400.

The computing device also includes a storage device 424. The storage device 424 is a physical memory such as a hard drive, an optical drive, a thumbdrive, an array of drives, or any combinations thereof. The storage device 424 may also include remote storage drives. The storage device 424 includes any number of applications 426 that are configured to run on the computing device 400. The applications 426 may be used to combine the media and graphics, including 3D stereo camera images and 3D graphics for stereo displays. In examples, an application 426 may be used compose pipelines automatically, in accordance with embodiments of the present techniques.

The computing device 400 may also include a network interface controller (NIC) 428 may be configured to connect the computing device 400 through the bus 406 to a network 430. The network 430 may be a wide area network (WAN), local area network (LAN), or the Internet, among others.

In some embodiments, an application 426 can process image data and send the processed data to a print engine 432. The print engine 432 may process the image data and the send the image data to a printing device 434. The printing device 434 can include printers, fax machines, and other printing devices that can print the image data using a print object module 436. In embodiments, the print engine 432 may send data to the printing device 434 across the network 430.

The block diagram of FIG. 4 is not intended to indicate that the computing device 400 is to include all of the components shown in FIG. 4. Further, the computing device 400 may include any number of additional components not shown in FIG. 4, depending on the details of the specific implementation.

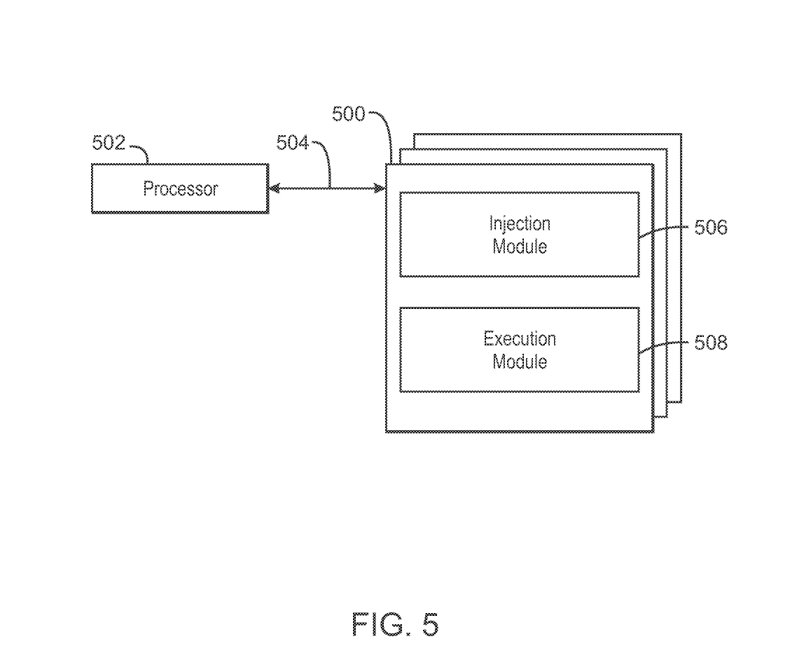

FIG. 5 is a block diagram showing tangible, non-transitory computer-readable media 500 that stores code for automatic pipeline composition, in accordance with embodiments. The tangible, non-transitory computer-readable media 500 may be accessed by a processor 502 over a computer bus 504. Furthermore, the tangible, non-transitory computer-readable media 500 may include code configured to direct the processor 502 to perform the methods described herein.

The various software components discussed herein may be stored on the tangible, non-transitory computer-readable media 500, as indicated in FIG. 5. For example, an injection module 506 may be configured to inject syntax elements into a code, wherein the syntax elements specify independent functions to be coalesced into a single loop, and data accesses to be coalesced for each function. An execution module 508 may be configured to execute the pipeline, wherein the pipeline comprises the coalesced functions and data accesses.

The block diagram of FIG. 5 is not intended to indicate that the tangible, non-transitory computer-readable media 500 is to include all of the components shown in FIG. 5. Further, the tangible, non-transitory computer-readable media 500 may include any number of additional components not shown in FIG. 5, depending on the details of the specific implementation.

### EXAMPLE 1

A system for automatic pipeline composition is described herein. The system includes a processor, wherein the processor executes code. The system also includes a code store, wherein syntax elements are injected into a code within the code store. The syntax elements specify independent functions to be coalesced into a single loop, and data accesses to be coalesced for each function. A compiler may use compiler flags to inject syntax elements into the code. A user may explicitly insert syntax elements into the code. Injecting syntax elements may include automatically inferring the syntax elements using static code analysis. Injecting syntax elements may also include explicitly indicating the syntax elements using pragmas or special data types. The syntax elements may be data attributes that describe the organization of the data, or the syntax elements may be compute attributes that describe the data types, functions, and buffer sizes to be coalesced. The processor may inject syntax elements into the code using native language of the processor prior to the execution of the code. Further, a compiler may inject syntax elements into the code at an intermediate level, wherein the intermediate level is based on an abstraction of a hardware of the system. The syntax elements may also be injected into high level programming languages, or the syntax elements are injected into a compiler or translator. A run time system may generate optimized machine code using syntax elements which executes on a target processor.

### EXAMPLE 2

An apparatus for automatic pipeline composition is described herein. The apparatus includes logic to inject syntax elements into a code, wherein the syntax elements specify independent functions to be coalesced into a single loop, and data accesses to be coalesced for each function. The apparatus also includes logic to execute the pipeline, wherein the pipeline comprises the coalesced functions and data accesses. Injecting syntax elements may include automatically inferring the syntax elements using compiler flags. Injecting syntax elements may also include automatically inferring the syntax elements using static code analysis. Additionally, injecting syntax elements may include explicitly indicating the syntax elements using pragmas or special data types. The syntax elements may be data attributes that describe the organization of the data. Further, the syntax elements may be compute attributes that describe the data types, functions, and buffer sizes to be coalesced. A run time system may generate optimized machine code using syntax elements which executes on a target processor. Additionally, the apparatus may be a printing device or an image capture device.

### EXAMPLE 3

At least one machine readable medium is described herein. The machine readable medium includes instructions that, in response to being executed on a computing device, cause the computing device to inject syntax elements into a code, wherein the syntax elements specify independent functions to be coalesced into a single loop, and data accesses to be coalesced for each function. The instruction may also cause the computing device to execute the pipeline, wherein the pipeline comprises the coalesced functions and data accesses. The syntax elements may be data attributes that describe the organization of the data. Additionally, the syntax elements may be compute attributes that describe the data types, functions, and buffer sizes to be coalesced. Injecting the syntax elements may include automatically inferring the syntax elements using compiler flags. Further, injecting the syntax elements may include automatically inferring the syntax elements using static code analysis. Moreover, injecting syntax elements may include explicitly indicating the syntax elements using pragmas or special data types. A run time system may generate optimized machine code using syntax elements which executes on a target processor.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A system for automatic pipeline composition, wherein the system comprises:
a processor, wherein the processor executes code; and
a code store, wherein syntax elements are injected into a code within the code store, wherein the syntax elements specify independent functions to be coalesced into a single loop, and data accesses to be coalesced for each function.

2. The system of claim 1, wherein a compiler uses compiler flags to inject syntax elements into the code.

3. The system of claim 1, wherein a user explicitly inserts syntax elements into the code.

4. The system of claim 1, wherein injecting syntax elements comprises automatically inferring the syntax elements using static code analysis.

5. The system of claim 1, wherein injecting syntax elements comprises explicitly indicating the syntax elements using pragmas or special data types.

6. The system of claim 1, wherein the syntax elements are data attributes that describe the organization of the data.

7. The system of claim 1, wherein the syntax elements are compute attributes that describe the data types, functions, and buffer sizes to be coalesced.

8. The system of claim 1, wherein the processor injects syntax elements into the code using native language of the processor prior to the execution of the code.

9. The system of claim 1, wherein a compiler injects syntax elements into the code at an intermediate level, wherein the intermediate level is based on an abstraction of a hardware of the system.

10. The system of claim 1, wherein the syntax elements are injected into high level programming languages or the syntax elements are injected by a compiler or a translator.

11. The system of claim 1, where a run time system generates optimized machine code using syntax elements which executes on a target processor.

12. An apparatus for automatic pipeline composition, comprising:
logic to inject syntax elements into a code, wherein the syntax elements specify independent functions to be coalesced into a single loop, and data accesses to be coalesced for each function;
logic to execute the pipeline, wherein the pipeline comprises the coalesced functions and data accesses.

13. The apparatus of claim 12, wherein the logic to inject syntax elements comprises automatically inferring the syntax elements using compiler flags.

14. The apparatus of claim 12, wherein the logic to inject syntax elements comprises automatically inferring the syntax elements using static code analysis.

15. The apparatus of claim 12, wherein the logic to inject syntax elements comprises explicitly indicating the syntax elements using pragmas or special data types.

16. The apparatus of claim 12, wherein the syntax elements are data attributes that describe the organization of the data.

17. The apparatus of claim 12, wherein the syntax elements are compute attributes that describe the data types, functions, and buffer sizes to be coalesced.

18. The apparatus of claim 12, further comprising a run time system to generate optimized machine code using syntax elements which execute on a target processor.

19. The apparatus of claim 12, wherein the apparatus is a printing device.

20. The apparatus of claim 12, wherein the apparatus is an image capture mechanism.

21. At least one machine readable medium having instructions stored therein that, in response to being executed on a computing device, cause the computing device to:
inject syntax elements into a code, wherein the syntax elements specify independent functions to be coalesced into a single loop, and data accesses to be coalesced for each function;
execute the pipeline, wherein the pipeline comprises the coalesced functions and data accesses.

22. The at least one machine readable medium of claim 21, wherein the syntax elements are data attributes that describe the organization of the data.

23. The at least one machine readable medium of claim 21, wherein the syntax elements are compute attributes that describe the data types, functions, and buffer sizes to be coalesced.

24. The at least one machine readable medium of claim 21, wherein injecting syntax elements comprises automatically inferring the syntax elements using compiler flags.

25. The at least one machine readable medium of claim 21, wherein injecting syntax elements comprises automatically inferring the syntax elements using static code analysis.

26. The at least one machine readable medium of claim 21, wherein injecting syntax elements comprises explicitly indicating the syntax elements using pragmas or special data types.

27. The apparatus of claim 21, where a run time system generates optimized machine code using syntax elements which executes on a target processor.
